(19) United States
(12) Patent Application Publication
(10) Pub. No.: US 2003/0060217 A1
(43) Pub. Date: Mar. 27, 2003

(54) Emulating push functionality in cellular data networks

(76) Inventors: Robert C. Knauerhase, Portland, OR (US); Nikhil Deshpande, Beaverton, OR (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 09/960,120

(22) Filed: Sep. 21, 2001

(51) Int. Cl. H04Q 7/20

(52) U.S. Cl. 455/466; 455/422

(57) ABSTRACT

In one aspect of the invention is a method for emulating push functionality in a cellular data network. Data is detected for a client on one of several servers in a cellular network. In response to detecting data, a paging address for the client is determined. Using a paging functionality, a page is sent to the client. The client can then connect to the network to receive the data.

### COPYRIGHT NOTICE

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright© 2001, Intel Corporation, All Rights Reserved.

### FIELD OF THE INVENTION

This invention relates to the field of cellular based data networks, and, more particularly, to a method of improving data transmission to clients on these networks.

### BACKGROUND OF THE INVENTION

In cellular based networks, mobile devices (a phone, personal digital assistant, and laptop, for instance, hereinafter referred to as “cellular clients”) are connected to a network. Since these networks support TCP/IP (Transmission Control Protocol/Internet Protocol) sockets, cellular clients can establish connections with arbitrary servers on the Internet.

In the current state of cellular networks, cellular clients frequently cannot receive data connections from these networks, i.e., they cannot listen on a socket and await connection from a server or peer (i.e., other cellular clients). Consequently, the “push” model of data distribution does not work for cellular clients on these networks.

Instead, cellular clients may receive data from cellular networks manually by calling in at various times determined by the user, or automatically at predetermined intervals. The latter of these methods is called polling. Polling is one way in which the “push” method of data distribution can be emulated. Polling, however, has some disadvantages. For one, it is an inefficient use of the client's battery life. Also, it can be potentially costly to the user, depending on how the data usage is billed. Furthermore, the polling interval may differ in different applications, with no good way to predetermine an optimal interval.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a cellular network in an exemplary embodiment.

FIG. 2 illustrates an interceptor in a cellular network in accordance with embodiments of the invention.

FIG. 3 is a flowchart illustrating a method in accordance with embodiments of the invention.

FIG. 4 is a flowchart illustrating a method for a client in accordance with embodiments of the invention.

### DETAILED DESCRIPTION OF THE INVENTION

In one aspect of the invention is a method for emulating push functionality in a cellular data network. When a given server in the cellular network receives data for a given client, an interceptor in communication with the server determines the client's paging address, and utilizes a paging functionality to notify the client that it has data. In response to this notification, the client connects to the server and requests the data. The server sends the data to the client in response to this request.

The present invention includes various operations, which will be described below. The operations of the present invention may be performed by hardware components or may be embodied in machine-executable instructions, which may be used to cause a general-purpose or special-purpose processor or logic circuits programmed with the instructions to perform the operations. Alternatively, the operations may be performed by a combination of hardware and software.

The present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electromagnetic Erasable Programmable Read Only Memories), magnetic or optical cards, flash memory, or other type of media/machine-readable medium suitable for storing electronic instructions.

Moreover, the present invention may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Introduction

In embodiments of the invention, a cellular based network may comprise GPRS (General Packet Radio System) or CDPD (Cellular Digital Packet Data), for example. Furthermore, a client may comprise a mobile device such as a phone, a PDA (Personal Digital Assistant), or a laptop, which supports TCP/IP (Transmission Control Protocol/Internet Protocol) sockets that enables the client to establish connections with arbitrary servers on the Internet.

For purposes of illustration, the GPRS network is described herein. A GPRS network is a service that provides actual packet radio access for mobile Global System for Mobile Communications (GSM) and time-division multiple access (TDMA) users. Some of the benefits of GPRS are that it reserves radio resources only when there is data to send and it reduces reliance on traditional circuit-switched network elements.

Under the current state of cellular networks, data can only be pulled from the network, rather than pushed. Pull refers to the demanding of data in real time by a user. Push refers to the transmission of data at a predetermined time, or under predetermined conditions, such as when data is received. While push functionality can be emulated using polling, polling can be an inefficient use of the client's battery life. Also, it can be potentially costly to the user, depending on how the data usage is billed. Furthermore, the polling interval may differ in different applications, with no good way to predetermine an optimal interval.

In embodiments of the invention, paging functionality is used to emulate push functionality in cellular networks. In the GPRS network, for example, paging functionality is achieved using the cellular based Short Message Service (hereinafter “SMS”). SMS is a bi-directional service used by various cellular networks for short alphanumeric messages that are transported in a store-and-forward fashion. While SMS paging services are described herein, it is envisioned that any network having an appropriate paging network may be used, and that it is not necessary to use a cellular based paging functionality.

Exemplary Embodiment

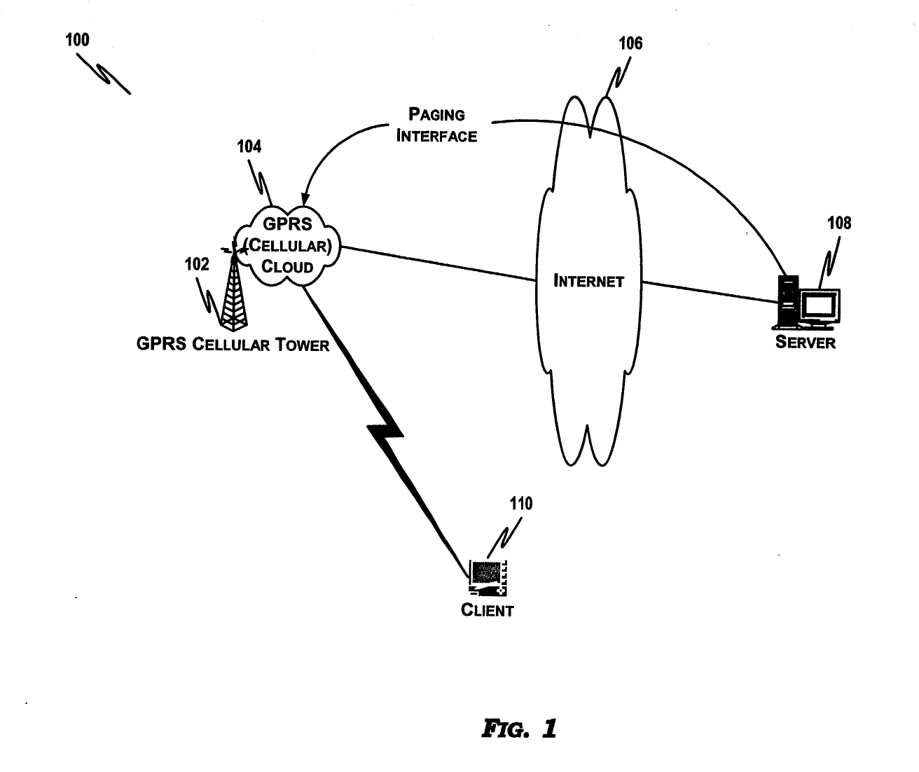

A GPRS network 100 is illustrated in FIG. 1. It comprises a GPRS cellular tower 102 that transmits data across the Internet 106 between one or more servers 108 (only one shown) and one or more clients 110 (only one shown) through GPRS services as represented by a GPRS cloud 104. GPRS services comprise, for example, SMS.

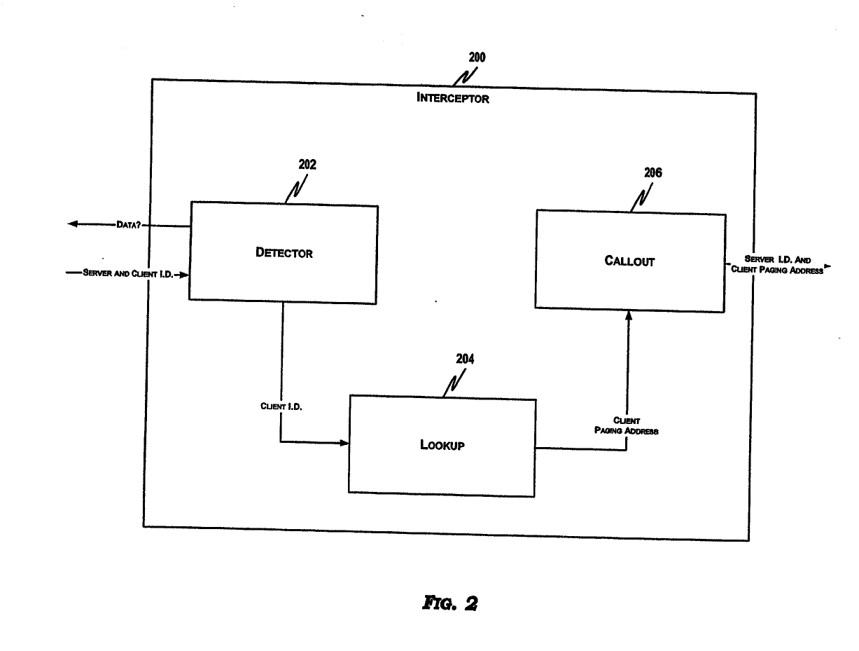

As shown in FIG. 2, when a server 108 receives data, a detector module 202 of an interceptor 200 detects the data. An interceptor 200 may, for example, be part of the GPRS services 104 for monitoring the servers 108 in its network 100, or the interceptor may be integrated with each server 108. The detector then determines which server 108 the data is located on, and which client 110 the data belongs to.

A lookup module 204 of the interceptor 200 obtains the paging address for the client 110. A callout module 206 of the interceptor 200 then accesses the SMS services of the GPRS services 104 using a paging interface, and passes in the paging address 208 for the client 110. The SMS pages the client 110, notifying the client 110 that it has data from a given server 108.

The client 110 may then establish a connection with the server 108. This connection may be made manually by a user on the client 110, in which case the user would utilize a server I.D. to establish the connection. This connection may, alternatively, be made automatically, in which case the client 110 would automatically establish a connection with the server 108 in response to receiving notification that it has data.

While the detector module, lookup module, and callout module are described and illustrated herein as three separate modules, it should be understood by one of ordinary skill in the art that the modules need not be distinct, individual modules. The modules should be understood as comprising the functionality described herein, and that the functionality may, instead, be embedded in a single module, or any other combination of modules.

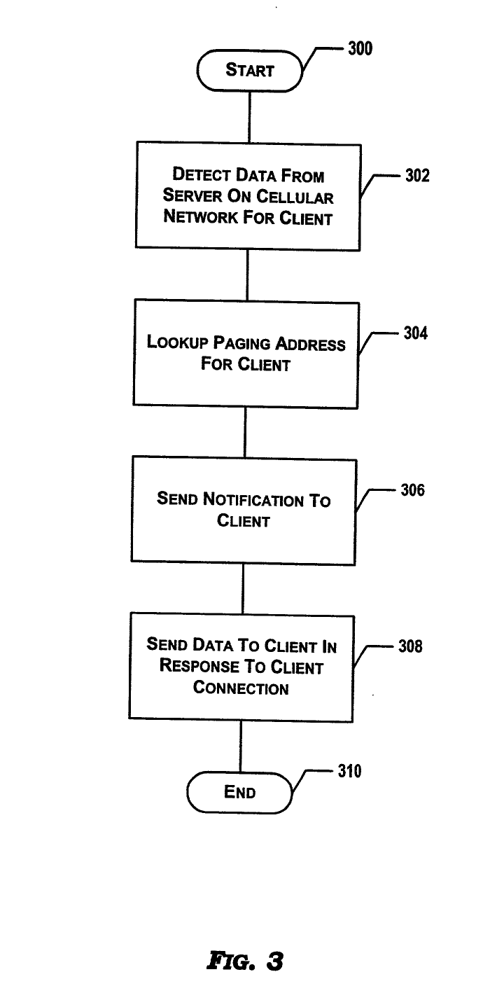

FIG. 3 is a flowchart illustrating a method in accordance with embodiments of the invention. The method begins at block 300 and continues to block 302 where data is detected on a server for a given client on the cellular network. At block 304, a paging address for the client is determined, and at block 306, notification via a page is sent to the client that it has data. At block 308, the data is sent to the client from the server in response to the client connecting to the network. The method ends at block 310.

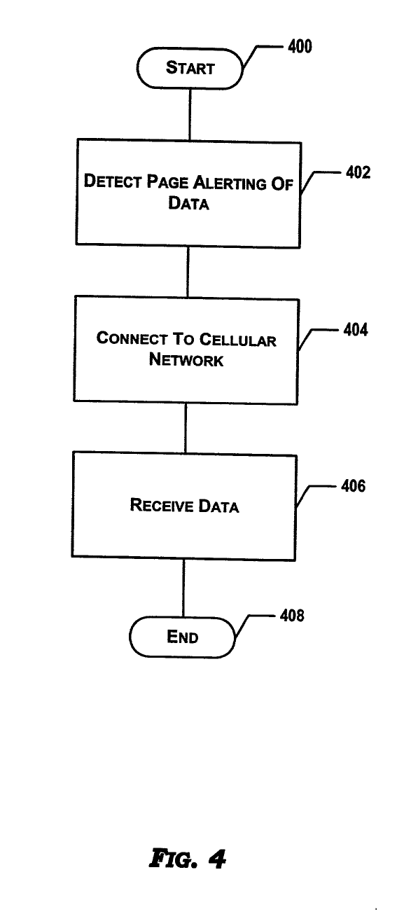

FIG. 4 is a flowchart illustrating a method for a client in accordance with embodiments of the invention. The method begins at block 400 and continues to block 402 where a client detects a page alerting the client that one of the servers on a cellular network has data for the client. At block 404, the client connects to the network, and at block 406, the client receives the data. The method ends at block 408.

### CONCLUSION

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

For example, while the GPRS network has been described herein, it should be obvious to one of ordinary skill in the art that the concepts of this invention are not strictly limited to such a network. In fact, other cellular networks, such as CDPD may be used.

What is claimed is:

1. A method comprising:
detecting data for a client, the data being detected on a server in a cellular network having one or more servers;
determining the client's paging address;
utilizing a paging functionality to notify the client that the client has data; and
in response to the client connecting to the cellular network and requesting the data, sending the data to the client.

2. The method of claim 1, wherein the sending the data to the client comprises sending the data to the client using TCP/IP (Transmission Control Protocol/Internet Protocol).

3. The method of claim 1, wherein the cellular based network comprises GPRS (General Packet Radio System).

4. The method of claim 3, wherein the paging functionality comprises a cellular based paging functionality.

5. The method of claim 4, wherein the paging functionality comprises SMS (Short Message System).

6. A method comprising:
receiving a page from a paging functionality, the page being indicative of data arriving on one of a number of servers in a cellular network; and
in response to receiving the page, connecting to the cellular network to receive the data.

7. The method of claim 6, wherein the cellular-telephony-based network comprises GPRS (General Packet Radio System).

8. The method of claim 7, wherein the paging functionality comprises SMS (Short Message System).

9. The method of claim 6, wherein the page comprises a server identification corresponding to the server.

10. The method of claim 6, wherein the connection is made automatically.

11. The method of claim 6, wherein the connection is made manually by a user on the client.

12. The method of claim 6, wherein the client comprises a mobile device.

13. An apparatus comprising:
a detector module to detect data arriving for a given client on a server in a cellular network having one or more servers;
a lookup module to determine the given client's paging address in response to the detector module detecting data arriving on one of the servers, the determining in response to the detector module detecting data; and
a callout module to utilize a paging functionality to notify the client that the client has data, the notifying in response to the lookup module determining the client's paging address.

14. The apparatus of claim 13, wherein the cellular network comprises GPRS (General Packet Radio System).

15. The apparatus of claim 14, wherein the paging functionality comprises a cellular based paging functionality.

16. The method of claim 15, wherein the paging functionality comprises SMS (Short Message System).

17. An apparatus comprising:
means for detecting data arriving for a given client on a server in a cellular network having one or more servers;
means for determining the given client's paging address in response to the detector module detecting data arriving on one of the servers, the determining in response to the detector module detecting data; and
means for utilizing a paging functionality to notify the client that the client has data, the notifying in response to the lookup module determining the client's paging address.

18. The apparatus of claim 17, wherein the client comprises a mobile device.

19. The apparatus of claim 17, wherein the cellular network comprises GPRS (General Packet Radio System).

20. The method of claim 19, wherein the paging functionality comprises SMS (Short Message System).

21. A system comprising:
at least one server, the server to:
receive data for one or more clients in a cellular network;
send the data to a given one of the clients in response to the given client connecting to the network and requesting the data; and
an interceptor in communication with the at least one server, the interceptor to:
detect that one of the at least one servers has received data for a given client;
determine the given client's paging address; and
utilize a paging functionality to notify the given client that the given client has data; and
the paging functionality in communication with the interceptor to notify the given client that the given client has data.

22. The system of claim 21, wherein the cellular network comprises GPRS (General Packet Radio System).

23. The method of claim 22, wherein the paging functionality comprises a cellular based paging functionality.

24. A machine-readable medium having stored thereon data representing sequences of instructions, the sequences of instructions which, when executed by a processor, cause the processor to perform the following:
detect data for a client, the data being detected on a server in a cellular network having one or more servers;
determine the client's paging address;
utilize a paging functionality to notify the client that the client has data; and
in response to the client connecting to the cellular network and requesting the data, send the data to the client.

25. The method of claim 24, wherein the sending the data to the client comprises sending the data to the client using TCP/IP (Transmission Control Protocol/Internet Protocol).

26. The method of claim 24, wherein the cellular based network comprises GPRS (General Packet Radio System).

27. The method of claim 26, wherein the paging functionality comprises SMS (Short Message System).

28. An apparatus comprising:
at least one processor; and
a machine-readable medium having instructions encoded thereon, which when executed by the processor, are capable of directing the processor to:
detect data for a client, the data being detected on a server in a cellular network having one or more servers;
determine the client's paging address;
utilize a paging functionality to notify the client that the client has data; and
in response to the client connecting to the cellular network and requesting the data, send the data to the client.

29. The method of claim 28, wherein the sending the data to the client comprises sending the data to the client using TCP/IP (Transmission Control Protocol/Internet Protocol).

30. The method of claim 28, wherein the cellular based network comprises GPRS (General Packet Radio System).
